(19) United States
(12) Patent Application Publication
(10) Pub. No.: US 2009/0055923 A1
(43) Pub. Date: Feb. 26, 2009

(54) Operation system login method and electronic device using the same

(75) Inventors: Yun-Liang Huang, Taipei (TW); Hsuan-Chih Peng, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/007,726

(22) Filed: Jan. 15, 2008

(30) Foreign Application Priority Data
Aug. 24, 2007 (TW) 96131586

(51) Int. Cl. G06F 21/00

(52) U.S. Cl. 726/18

(57) ABSTRACT

An operating system login method and an electronic device using the same are provided. The operating system login method comprises the following steps. Firstly, a facial characteristic of a user is captured. Next, whether the facial characteristic of the user is stored in a database is determined. If the facial characteristic is stored in the database, then a login user's account number and password are automatically read from the database. Then, whether the login user's account number and password pass verification is determined. If the user's account number and password pass verification, then the user is allowed to login the operating system.

This application claims the benefit of Taiwan application Serial No. 96131586, filed Aug. 24, 2007, the subject matter of which is incorporated herein by reference.

### BACKGROUND OF THE INVENTION

1. Field of the Invention

The invention relates in general to an operating system login method and an electronic device using the same, and more particularly to an operating system login method employing image recognition technology and an electronic device using the same.

2. Description of the Related Art

The protection of computer system and personal data has always been a focus of concern for the users of a computer system. Conventional text login procedure verifies the user's identity according to a set of personal account number and password. However, as pure text verification can be easily encrypted or invaded, conventional recognition procedure is unable to assure verification security. If the computer system allows an invader to login, the user's important data such as business secrets, Internet credit card details and Internet banking transactions may be stolen.

To use a conventional text login procedure, the user has to remember several sets of account number and password, and the user will be unable to login the computer system should the user forget his/her account number and password.

### SUMMARY OF THE INVENTION

The invention is directed to an operating system login method and an electronic device using the same. According to the facial characteristic technology, the user's personal facial characteristic enables the user to login an operating system, hence achieving a new security verification mechanism. The user's facial characteristic can be analyzed and defined according to the user's facial image captured by the digital lens of a computer when the user is within an effective range of the computer. The verification of the user's identity is determined according to the comparison between the facial characteristic captured by the computer's digital lens and the facial characteristic data read from the database.

According to a first aspect of the present invention, an operating system login method is provided. The operating system login method comprises the following steps. Firstly, a facial characteristic of a user is captured. Next, whether the facial characteristic of the user is stored in a database is determined. If the facial characteristic is stored in the database, then a login user's account number and password are automatically read from the database. Then, whether the login user's account number and password pass verification is determined. If the user's account number and password pass verification, then the user is allowed to login the operating system.

According to a second aspect of the present invention, an electronic device comprising an image capturing unit, a database and a processing unit is provided. The image capturing unit is used for capturing a facial characteristic of a user. The processing unit is used for determining whether the user's facial characteristic is stored in the database. If the user's facial characteristic is stored in the database, then the user is allowed to login the operating system.

The invention will become apparent from the following detailed description of the preferred but non-limiting embodiments. The following description is made with reference to the accompanying drawings.

### BRIEF DESCRIPTION OF THE DRAWINGS

FIG. 1 is a functional block diagram of an electronic device according to a preferred embodiment of the invention; and

FIG. 2 is a flowchart of an operating system login method according to a preferred embodiment of the invention.

### DETAILED DESCRIPTION OF THE INVENTION

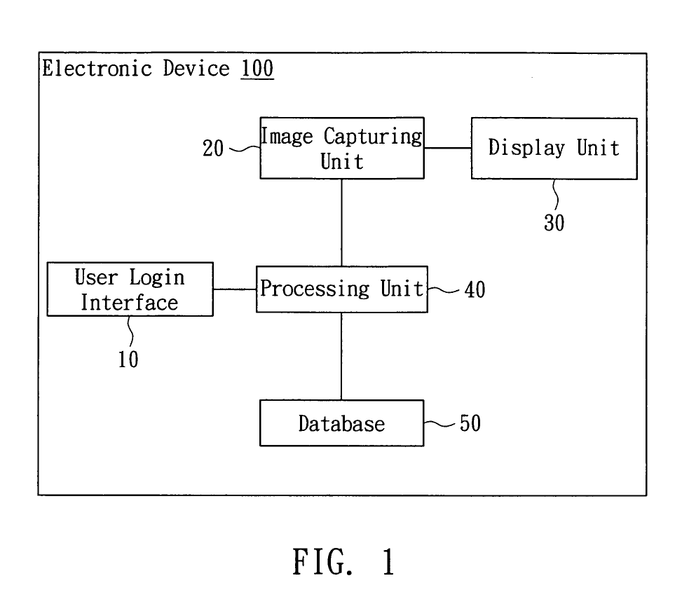

Referring to FIG. 1, a functional block diagram of an electronic device according to a preferred embodiment of the invention is shown. The electronic device 100 enables the user to login an operating system (not illustrated) by a facial characteristic login procedure (not illustrated). The electronic device 100 comprises an image capturing unit 20, a processing unit 40 and a database 50. The image capturing unit 20 is used for capturing a facial characteristic of the user. The processing unit 40 is used for determining whether the facial characteristic of the user is stored in the database 50. If the facial characteristic is stored in the database 50, then the user is allowed to login the operating system.

The electronic device 100 further comprises a user login interface 10 and a display unit 30. The user login interface 10 is used for choosing a text login procedure or a facial characteristic login procedure. For example, when the operating system requests a user to go through verification, the processing unit 40 activates the user login interface 10 for the user to select a text login procedure or a facial characteristic login procedure.

At least a facial image of the user is captured by the image capturing unit 20 and analyzed by the processing unit 40 so as to generate the user's facial characteristic. The facial characteristic comprises a plurality of characteristic parameters such as facial contour, relative position between the five sense organs, skin colors and so on. Moreover, when capturing a facial image, the display unit 30 displays the user's facial image for the user to preview.

The database 50 stores several sets of user account number and password. When the processing unit 40 determines that the facial characteristic of the user is stored in the database 50, the processing unit 40 automatically read the user's account number and password from the database 50 to login the operating system.

In other words, when the user logins the operating system, the operating system requests the user to go through verification. The user may select a facial characteristic login procedure from the user login interface 10. The display unit 30 immediately displays the user's facial image, and concurrently captures at least a facial image of the user by the image capturing unit 20 for the processing unit 40 to analyze the facial image and generate the user's facial characteristic accordingly. If the facial characteristic is stored in the database 50, the processing unit 40 automatically reads the user's account number and password from the database 50 to login the operating system.

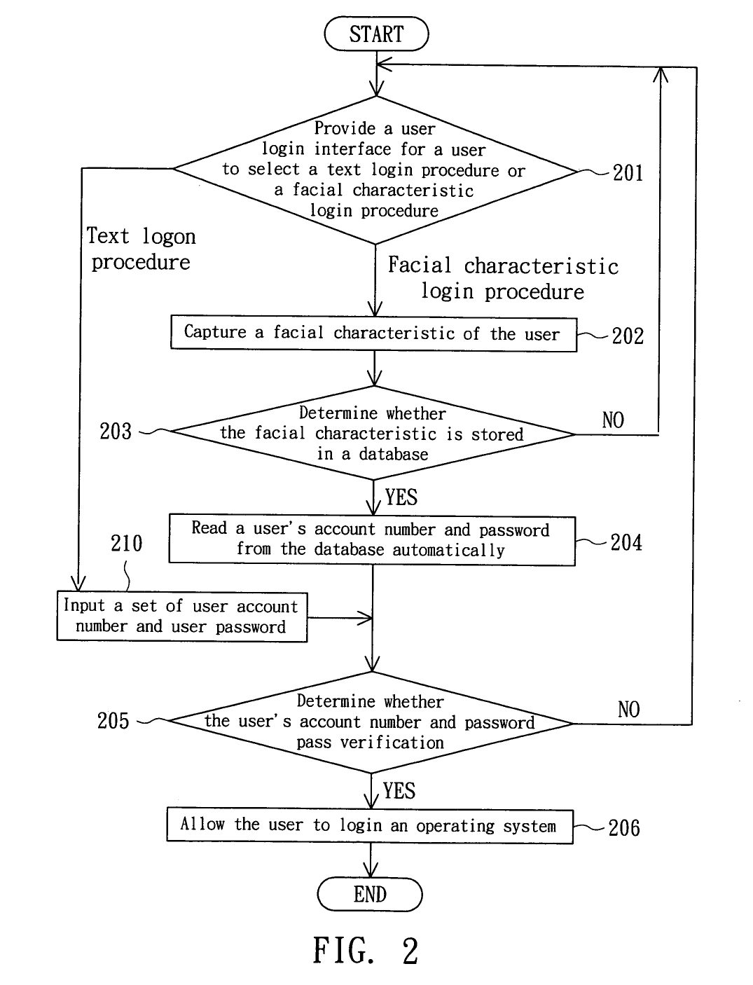

Referring to FIG. 2, a flowchart of an operating system login method according to a preferred embodiment of the invention is shown. Firstly, as indicated in step 201, the user login interface 10 is provided for the user to select a text login procedure or facial characteristic login procedure. If the user selects the facial characteristic login procedure, then the method proceeds to step 202. If the user selects the text login procedure, then the method proceeds to step 210.

Then, the method proceeds to step 202, the image capturing unit 20 captures and analyzes at least a facial image of the user's facial characteristic to generate the user's facial characteristic. In step 202, the processing unit 40 activates the image capturing unit 20 and displays a facial image of the user on a display screen 30. Then, the image capturing unit 20 captures at least a facial image of the user. Then the processing unit 40 analyzes the facial image to generate the user's facial characteristic. The facial characteristic of the user is generated through a series of technologies such as facial contour tracking technology, facial characteristic retrieving technology and face recognition technology.

Next, the method proceeds to step 203, whether the facial characteristic of the user is stored in a database 50 is determined. If the facial characteristic is stored in the database 50, then the method proceeds to step 20. If the facial characteristic is not stored in the database 50, then the method returns to the beginning of the flowchart.

Then, the method proceeds to step 204. If the facial characteristic is stored in the database 30, then the user's account number and password are automatically read from the database.

Next, the method proceeds to step 205, whether the account number and the password pass verification is determined by the processing unit 40. If the user's account number and password pass verification, then the method proceeds to step 206. If the user's account number and password do not pass verification, then the method returns to the beginning of the flowchart

Then, the method proceeds to step 206, the user is allowed to login an operating system.

On the other hand, if a text login procedure is chosen in step 201, then the method proceeds to step 210.

In step 210, the user is requested to input a set of account number and password. Then, the method proceeds to step 205, whether the user's account number and password pass verification is determined. If the user's account number and password pass verification, then the method proceeds to step 206. If the user's account number and password do not pass verification, then the method returns to the beginning of the flowchart.

In the present embodiment of the inventing, the user only needs to select a facial characteristic login procedure from the user login interface. If the user's facial characteristic passes verification, the user is enabled to login the operating system without having to remember complicated account number and password, and this is very convenient to the user.

Preferably, the operating system is Microsoft Vista but the invention is not limited thereto. Microsoft Vista operating system is configured with the structure of credential provider (CP), wherein the credential provider operates under a session X work stage and provides credential information to the local security authorization sub-system service (LSASS) when the operating system requests the user to go through verification. Microsoft Vista operating system can have many session work stages at the same time and the LSASS operates under the session 0 work stage of Microsoft Vista operating system. Therefore the session X work stage operated according to the operating system login method of the present embodiment of the inventing is different and separated from the session 0 work stage (the session X is a work stage other than session 0), so that the user can use the operating system login method of the present embodiment of the inventing at any time.

Moreover, the credential provider can be loaded with one or several login procedures. For example, the credential provider is loaded with the facial characteristic login procedure and the text login procedure of the present embodiment of the inventing, hence providing more convenience to the user.

As the facial characteristic login procedure requires the user's personal facial characteristic for verification, so the uniqueness of user's identity is achieved and system security is assured.

During the facial characteristic login procedure, the user's facial image can be stored separately so that other users' invasions are recorded.

Also, the image capturing unit can be built-in the electronic device to reduce hardware cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An operating system login method, comprising:
(a) providing a user login interface for a user to select a text login procedure or a facial characteristic login procedure, wherein if the user selects the facial characteristic login procedure, then the method proceeds to step (b);
(b) capturing a facial characteristic of the user;
(c) determining whether the facial characteristic is stored in a database;
(d) reading the user's account number and password from the database automatically if the facial characteristic is stored in the database;
(e) determining whether the user's account number and password pass verification; and
(f) allowing the user to login an operating system if the user's account number and password pass verification.

2. Then operating system login method according to claim 1, wherein in the step (b), the facial characteristic of the user is captured by an image capturing unit, and before the step (b), the operating system login method further comprises:
(g) activating the image capturing unit.

3. Then operating system login method according to claim 1, wherein the step (b) further comprises:
(b1) capturing at least a facial image of the user; and
(b3) analyzing the facial image to generate the facial characteristic.

4. Then operating system login method according to claim 3, wherein the step (b) further comprises:
(b2) displaying the facial image on a display screen.

5. Then operating system login method according to claim 1, wherein the operating system is Microsoft Vista operating system.

6. Then operating system login method according to claim 5, being operated under a session X work stage of Microsoft Vista operating system, wherein the session X work stage is different and separated from the session 0 work stage of Microsoft Vista operating system.

7. An electronic device, comprising:
an image capturing unit used for capturing a facial characteristic of a user;
a database;
a processing unit used for determining whether the facial characteristic of the user is stored in the database, wherein if the facial characteristic is stored in the database, then the user is allowed to login an operating system; and
a user login interface used for selecting a text login procedure or a facial characteristic login procedure.

8. Then electronic device according to claim 7, wherein the image capturing unit is used for capturing at least a facial image of the user, and the processing unit is used for analyzing the facial image to generate the facial characteristic.

9. Then electronic device according to claim 8, further comprises:
a display unit used for displaying the facial image.

10. Then electronic device according to claim 7, wherein the database is used for storing plural sets of user account number and user password, and if the facial characteristic is stored in the database, then the processing unit automatically read the user's account number and password from the database to login the operating system.

11. Then electronic device according to claim 7, wherein the operating system is Microsoft Vista operating system.
